(19) United States
(12) Patent Application Publication
(10) Pub. No.: US 2021/0237085 A1
(43) Pub. Date: Aug. 5, 2021

(54) CHEMICAL MICRO HEATING ELEMENT AND MICRO HEATING SYSTEM

(71) Applicants: Buddhisha Nayantara UDUGAMA, Vista, CA (US); Pranav Karthike KADHIRESAN, Toronto (CA); Warren C. W. CHAN, Toronto (CA)

(72) Inventors: Buddhisha Nayantara UDUGAMA, Vista, CA (US); Pranav Karthike KADHIRESAN, Toronto (CA); Warren C. W. CHAN, Toronto (CA)

(21) Appl. No.: 17/166,227

(22) Filed: Feb. 3, 2021

Related U.S. Application Data
(60) Provisional application No. 62/970,606, filed on Feb. 5, 2020.

(51) Int. Cl. B01L 7/02; B01L 7/00; B01L 3/00

(52) U.S. Cl. CPC B01L 7/02; F24H 1/208; B01L 3/502715; B01L 7/52

(57) ABSTRACT

Described are various embodiments of a reactive chemical exothermic heating element and system. The exothermic chemical heating element has a reactive solid holder having a channel therein with an exposed end. A reactive chemical is disposed in the channel and able to exothermically react with a suitable liquid, contained in a first vessel. On exposure to the suitable liquid, a gas is generated in the channel and a gas bubble emerges from the channel thereby limiting further suitable liquid from accessing the reactive chemical, and thus controlling the rate of the exothermic reaction and the energy released over a given time period to the suitable liquid. A second vessel may be disposed in the suitable liquid so as to heat any contents of the second vessel via a liquid bath of the second vessel.

### CROSS REFERENCE TO RELATED APPLICATIONS

This application claims the benefit of provisional patent application Ser. No. 62/970,606, filed Feb. 5, 2020, the contents of which are hereby incorporated by reference into the present disclosure.

### FIELD OF THE DISCLOSURE

The present disclosure relates to chemical heaters and, in particular, to micro-heaters wherein the reaction kinetics are modulated by the use of gas bubbles in a channel permitting the rate of chemical reaction.

### BACKGROUND

Point-of-care diagnostic assays, and situations where there is need to generate heat often involve multi-step reactions, which require precise temperatures across a wide range of temperatures. For example, point-of-care diagnostic assays often involve complex multi-step reactions that require a wide variety of temperatures for steps ranging from sample processing to genetic analysis. Existing methods that provide precise heating, such as thermocyclers, often rely on electricity. Although precise heating is critical to performing these assays, it is often challenging to provide such heat in an electricity-free format away from established infrastructure. By some estimates, electrification rates in resource poor settings can be as low as 10%, and power outages can leave consumers without access to electricity for over 50% of the hours annually. Therefore, in order to ensure point-of-care diagnostic utilization in such areas, it is paramount that reliance on infrastructure and electricity is minimized.

Biochemical techniques are required for a variety of different point-of-care applications, from diagnosing illnesses to manufacturing vaccines. However, to date, these applications are challenging to use in remote locations due to their reliance on electricity for temperature control. Chemical heaters are an electricity-free solution to providing precise heating for diagnostic assays. Generally, these heaters utilize an exothermic reaction coupled with a phase change material (PCM) and insulation to achieve the required temperature. However, these heaters are often unsuitable for conducting multi-step reactions at the point-of-care. Furthermore, they often lack portability, have narrow ranges of achievable temperatures, and long ramp-up times which increase overall turnaround times.

While a single temperature is useful for employing a specific enzyme, enzymatic reactions, which diagnostics assays often leverage, are known to span a range of temperatures: for example, from restriction endonucleases such as EcoR I performing optimally at 37° C. to Bst DNA polymerase performing optimally at 65° C. Known chemical heaters are therefore either limited to single step assays which only require a single temperature, or require multiple chemical heaters tuned to each required temperature may be required. Multiple heaters of the variety currently known in the art are a challenge to implement given their size and ramp up times. For example, chemical heaters currently known in the art may be up to 4,400 cm³ and have long ramp-up times, in the order of anywhere from 5 to 30 minutes. Therefore, in certain situations, it may be desirable to provide chemical heaters for precise electricity-free heating, where the chemical heaters have reduced overall size and improve flexibility, both in terms of turnaround time as well as achievable temperatures compared to those currently known in the art. Furthermore, in certain situations, it may be desirable for a heater, such as a chemical micro heating element, in addition to field-portability, to have a reduced size, and chemical stability, compared to currently available solutions, in addition to being employable in an electricity-free multi-step workflow which requires a range of temperatures.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

Disclosed herein is an exemplary chemical heater and heating element, which may also be termed herein as a miniature lithium heater. In some embodiments, the chemical heater may be up to 8000× smaller than existing technologies and thus be suitable for use in the execution of biochemical techniques at the point-of-care in an electricity-free environment.

In some embodiments, the instantly disclosed chemical micro heating elements may provide precise (within 5° C.) and tunable heating from 37-65° C. (ΔT_{RT}=12-40° C.) with ramp-up times of a minute. The chemical micro heating elements as disclosed herein are, in some embodiments, intended to be placed inside a vessel, for example a cuvette, and immersed in liquid, which may be water or a solution so as to render a heated liquid bath system capable of heating the contents of a second vessel placed in the liquid bath. Those of skill in the art will recognize from a reading of the instant disclosure that by manipulating certain variables disclosed herein that other temperatures and times may be achievable. This technology takes previously demanding situations, such as disaster relief camps or mountain expeditions, and gives them timely access to cutting edge diagnostic and therapeutic capabilities.

The chemical micro heating elements disclosed herein employ an interplay between an active chemical reaction and passive bubble flow to harness the energy from an otherwise unpredictable and reactive alkali metal. Although other reactive metals, such as sodium, potassium, or other chemicals, or combinations thereof, may be used, for the exemplary purposes of the instant disclosure, Lithium was chosen as a fuel source for a variety of reasons as discussed below in more detail below with regard to the exemplary embodiments. Accordingly, as disclosed herein, a chemical micro heating element has been developed which may be in the order of about >8000× smaller than chemical heaters currently known in the art, and which uses, in some embodiments, lithium and hydrogen bubble motion in tubes of different shapes to achieve a wide range of achievable temperatures and fast ramp up times compared to existing technologies.

A need exists for a chemical micro heating element which overcomes some of the drawbacks of known techniques, or at least, provides a useful alternative thereto. Some aspects of this disclosure provide examples of such a chemical micro heating element and chemical micro heaters using the element.

In accordance with one aspect, there is provided a heating element which comprises a reactive solid holder having a channel where the channel is defined about a perimeter thereof by at least one side wall. A chemical, which on contact with a suitable liquid undergoes an exothermic reaction and a gas is produced, is packed into the channel so as to completely fill the space afforded by the channel against the perimeter of the at least one side wall.

In some embodiments, the cross-section of the at least one side wall is a continuous loop. In some embodiments, the continuous loop is a circle or an oval. In some embodiments, the cross-section of the at least one side wall is a multi-sided loop having one or more angled corners. In some embodiments, the multi-sided loop having one or more angled corners has a cross-sectional shape of a square, a rectangle, a triangle, a star, pentagram, a heptagram a great heptagram, an octagram, an enneagegram, a great enneagram, a decagrams, a small hendecagrams, a handecagram, a great hendecagras, a grand hendecagram a dodecgram, a small tridecagram, a tridecagram, a medial tridecagram, a great tridecagram, a grand tridecagram, a tetratdecagram, a great tetradecagram, a small pentadecagram, a pentadecagrams, a great pentadecagram, a small dexadecagram, a hexadecagram, or a great hexadecagram.

In some embodiments, the channel is closed at one end thereof. In some embodiments, the channel is closed about the one end thereof by the coupling of a bottom seal to the reactive solid holder.

In some embodiments, the heating element further comprises a protective barrier for selectively sealing the chemical, located in the channel, from exposure. In some embodiments, the protective barrier is soluble in the suitable liquid so as to selectively allow exposure to the suitable liquid. In some embodiments, the protective barrier is contained in a protective barrier holder coupled to the reactive solid holder. In some embodiments, the protective barrier is comprised of at least mineral oil and mannitol.

In some embodiments, chemical is at least one reactive alkali metal. In some embodiments, the chemical is sodium, potassium, or lithium or combination thereof. In some embodiments, the chemical is lithium.

In some embodiments, the channel has an opening of from about 0.75 mm² to about 6 mm². In some embodiments, the channel has an opening of about 3 mm². In some embodiments, the channel as length of from about 0.01 mm to about 15.0 mm. In some embodiments, the channel as length about 9.525 mm.

In another aspect, there is provided bath heating system comprising the heating element as herein disclosed and a first vessel. The suitable liquid is contained in the first vessel and the liquid is suitable liquid to react with the chemical. In some embodiments, the suitable liquid is water.

In some embodiments, the suitable liquid is an aqueous solution. In some embodiments, the aqueous solution comprises SDS. In some embodiments, the aqueous solution comprises SDS and antifoam. In some embodiments, the concentration of SDS is from about 0.001% to about 3.0% In some embodiments, the concentration of SDS is about 1.0%.

In some embodiments, the suitable liquid is provided in a volume from about from about 0.5 mL to about 10 mL. In some embodiments, the suitable liquid is provided in a volume from about from about 1.0 mL to about 3.0 mL.

In some embodiments, the bath heating system further comprises a second vessel disposed in the suitable liquid for receiving therein a sample to be heated.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is schematic side view of an exemplary chemical micro heating element in a first vessel, to provide a micro heating system, with a portion of the chemical micro heating element and the immediate environment in an expanded view in accordance with the instant disclosure;

FIG. 2 is a perspective view of the chemical micro heating element of FIG. 1 showing bubbles in the channel and exiting therefrom and liquid contacting a reactive solid;

FIG. 3 is a photograph of an exemplary embodiment of the chemical micro heating element of FIGS. 1 and 2;

FIG. 4 is a perspective side of an exemplary chemical micro heating element of FIG. 1 prior to use showing the various components;

FIG. 5A shows a plurality of exemplary cross-sectional profiles of the channel of various embodiments of the chemical micro heating element of FIG. 1;

FIG. 5B is a photograph showing a plurality of various exemplary reactive solid holders of the chemical micro heating element of FIG. 1 where the channel has various cross-sectional profiles in accordance with various embodiments;

FIG. 6 is a schematic exemplary workflow for the production of the chemical micro heating elements disclosed herein;

FIG. 7 is an exemplary schematic diagram showing the installation of a malleable reactive solid into the channel of the chemical micro heating elements disclosed herein;

FIG. 8 is a side view of an exemplary embodiment of chemical micro heating element;

FIG. 9 is a line graph showing the change in temperature of samples versus time with different channel cross-sectional shapes of exemplary embodiments of the chemical micro heating elements;

FIG. 10 is a photograph showing hydrogen bubble production at various time points for star-shaped and circle-shaped channel cross-sectional shapes of exemplary embodiments of the chemical micro heating elements disclosed herein;

FIG. 11 is a schematic representation showing water access to lithium in star-shaped versus circular-shaped cross-sectional channels of exemplary embodiments the chemical micro heating elements disclosed herein;

FIG. 12 is a histogram showing the effect of varying the surface area of the opening of the channels of exemplary embodiments the chemical micro heating elements disclosed herein;

FIG. 13 is a histogram showing the effect of varying the immersion volume of water in which an exemplary embodiment of a chemical micro heating element is placed;

FIG. 14 is a histogram showing the total energy available from an exemplary embodiment of a chemical micro heating element and the total amount of energy transferred to sample in a set-up such as that shown in FIG. 8;

FIG. 15 is a graph showing the change in temperature versus time in a two-heating element approach with star-shaped cross-sectional channels having different surface areas;

FIG. 16 is a line graph showing the effect on temperature change in a 1 mL 1% SDS solution with the addition of more chemical micro heating elements as disclosed herein;

FIG. 17 is a line graph showing the effect of SDS concentration in bath solution temperature versus time with an embodiment of the chemical micro heating elements disclosed herein;

FIG. 18 is a line graph showing the effect of SDS concentration in bath solution temperature versus time with an embodiment of the chemical micro heating elements disclosed herein;

FIG. 19 is a schematic diagram showing the effect of SDS concentration in the bath solution on bubble size generation embodiments of the chemical micro heating elements disclosed herein;

FIG. 20 is a histogram shown the effect of channel depth on hold-over time;

FIG. 21 is a schematic diagram showing the effect of channel depth on hold-over time of an embodiment of the chemical micro heating elements disclosed herein;

FIG. 22 is a line graph showing the effect of channel depth on hold-over time;

FIG. 23 is a histogram showing the effect of channel opening surface area of the chemical micro heating elements disclosed herein on temperature and heating time;

FIG. 24 is a schematic exemplary workflow for the production of an exemplary embodiment of the chemical micro heating elements disclosed herein; and

FIG. 25 is a pair of line graphs showing the effect of relative humidity on performance of exemplary embodiments of the chemical micro heating elements following storage.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes, systems, or apparatuses that differ from those described below. The claimed implementations are not limited to apparatuses, systems or processes having all of the features of any one apparatus or process described below or to features common to multiple or all of the apparatuses, systems or processes described below. It is possible that an apparatus, system, or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

The systems and methods described herein provide, in accordance with different embodiments, different examples in relation a chemical micro heating element and chemical micro heater and system employing such a chemical micro heating element.

Briefly, in relation to the disclosed exemplary embodiments and in order to illustrate the inventive concepts disclosed herein, lithium was chosen as a fuel source for the heater due to its high energy density (˜222 kJ/mole), ease of malleability and simple activation with water. However, it should be understood that one of skill in the art, from a reading of the instant disclosure will appreciate that other reactive metals and/or chemical may be employed in the instantly disclosed system. Lithium's malleable nature allows for ease of controlling the shape and surface area of the alkali metal to provide predictable heating. Accordingly, for the purposes of the instantly disclosed system and concepts, the malleability of lithium allowed for the compression of the lithium into a channel where the lithium-water reaction could occur and act as a heater for the disclosed micro heating elements. Furthermore, the channel provides an enclosed space where aqueous reactants and gaseous products compete to occupy space within the system. By harnessing the high specific energy provided by lithium in a controlled manner, the design of a chemical heating element, and chemical heater employing such, for the point-of-care was enabled. It is envisioned by the inventors that this development may expedite the translation of complex biological assays to the point-of-care, with its applicability extending to biological applications such as gene editing or protein synthesis in environments devoid of electricity or at least a reliable source of electricity, as well as other environments as may be chosen by a user.

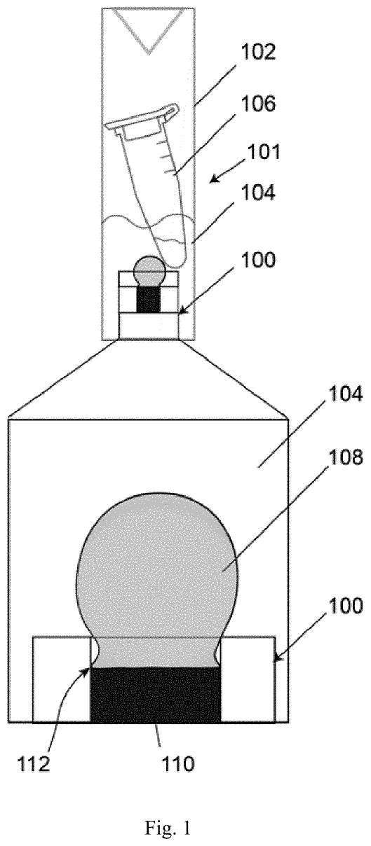

With reference to FIG. 1, and in accordance with at least one exemplary embodiment, a chemical micro heating element, and chemical micro heater 101 employing such, generally referred to using the numeral 100, will now be described. The chemical micro heating elements as disclosed herein are, in some embodiments, intended to be placed inside a vessel, for example a cuvette 102, and immersed in liquid 104, which may be water or a solution so as to render a heated liquid bath system 101 capable of heating the contents of a second vessel 106 placed in the liquid bath. In FIG. 1, the chemical microheater 100, is shown in a first vessel 102, which may be a cuvette 102 or first vessel 102, containing a bath solution 104, which may be water 104, and a test tube 106 or second vessel 106, thus showing an exemplary system for heating the contents which are held within the test tube 106. Briefly, as the water 104 contacts and reacts with a reactive chemical 110, which in the instant disclosure, for simplicity will generally be referred to as lithium 110, heat is generated by an exothermic reaction where a gaseous bubble 108 is generated and rises in the water 104. As the bubble 108 rises through the channel 112, due to the size and shape of the channel 112, the amount and rate at which water 104 is permitted to contact the lithium 110 is modulated. Accordingly, by varying the size and shape of the channel, the amount of energy transferred to the water 104 is regulated, thus controlling the temperature of the water 104 and the degree to which the contents of the test tube 106 are heated. Furthermore, the amount of water 104 and lithium 110 may be chosen to control the length of the exothermic reaction and thus the duration, also termed herein as hold-over time, of heating. In terms of the instant exemplary embodiment using lithium, the quantity of lithium and water may be provided so as to allow the exothermic reaction to proceed for a desired time until at least one of the reactants is exhausted according to the equation:

2Li₍ₛ₎+2H₂O_{(aq)}→2LiOH_{(aq)}+H_{2(g)} Equation 1

where 444 kJ of energy is produced. Those of skill in the art will know, from the stoichiometry of various reactive solids and liquids, how to calculate the various quantities required in order to allow a heating reaction to exhaustion therefore, providing heat for a desired period of time.

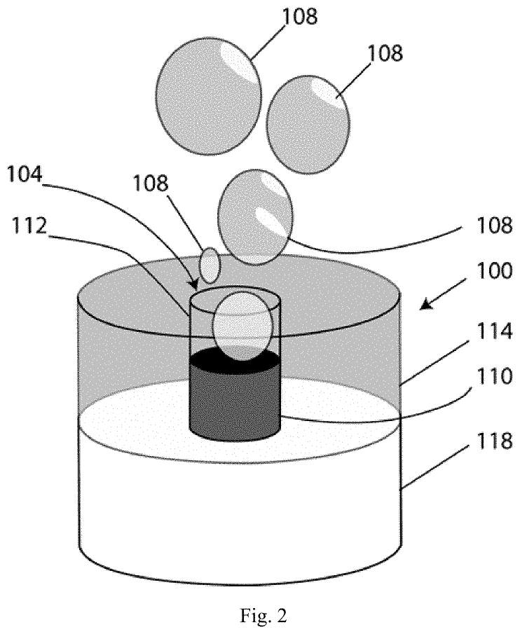

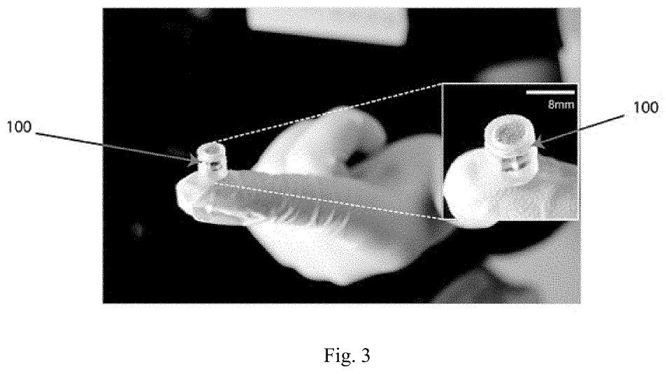

Turning now to FIG. 2, there is schematically shown water 104, or other liquid 104, entering the channel 112 so as to contact the lithium 110 or other reactive solid 110. As can be seen in FIG. 2, as the water 104 contacts the lithium, gas bubbles 108 are formed as a result of the chemical reaction. Therefore, in addition to heat being produced by the exothermic chemical reaction, gas is also produced (as is noted above in Equation 1). However, as the gas is generated, it must rise through the channel 112, thereby impeding the inflow of water 104 to be able to contact the lithium 110 and thus further react. Water 104 may not contact the lithium 110 at the bottom of the channel 112 until the bubble 108 has cleared, and then a new bubble 108 is produced, again impeding water 104 from contacting the lithium 110 until the new bubble 108 has cleared the channel. In this regard, the exothermic reaction is regulated to proceed at rate such that both the desired amount of energy can be transferred to heat the water 104 to a desired temperature and for a desired length of time and thus heat be transferred to the contents of the test tube 106. Accordingly, there is disclosed herein a miniature chemical heating element 100, which can fit on a fingertip, by harnessing the exothermic reaction of lithium 110 and water 104. The temperatures within the heater are thus controlled by modulating the interactions between the reactants, as schematically shown in FIG. 2. In terms of size of the chemical micro heating element 100, a photograph of a human finger holding an exemplary embodiment of the chemical micro heating element 100 disclosed herein is shown in FIG. 3.

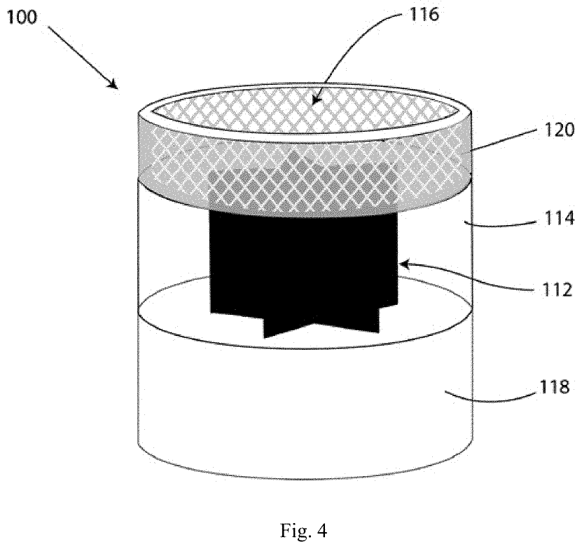

The modulation or regulation of the temperature of the water 104 is achieved by controlling the interface between the two reactants for i) heating as well as ii) storage. With reference to FIG. 4, there is shown an exemplary embodiment of a chemical micro heating element 100 in accordance with the instant disclosure. First, to control this interface for heating, a reactive solid holder 114 having the channel 112 is filled with lithium 110. More specifically, lithium's access to water 104 is modulated and the clearance of hydrogen bubbles is controlled by varying the channel 112 size and shape as well as the surface tension of water. Furthermore, the interface between lithium and water vapour in the air for storage is regulated with a sealed protective barrier 116, which in some embodiments, may be soluble. As lithium 110 is highly reactive with moisture in the air, in order to ensure that the heaters 110 may perform reproducibly even after shipping and storage, the protective barrier 116 reversibly seals the lithium 110 on one side of the channel and the on the opposing side of the channel 112 the lithium 110 is either reversibly or irreversibly (as may be desired in certain embodiments) sealed in the channel by the bottom seal 118 so that water vapour may not contact the surface of the lithium. The protective barrier 116, in order to allow water 104 to contact the lithium 110 during use, as desired, is fashioned from a soluble mixture of excipients which on contact with liquid water dissolve to allow the water 104 to contact the lithium 110. In some embodiments, the protective barrier 116 may be composed of a mixture of mineral oil and mannitol, as a soluble barrier for protection from water vapour in the air during storage. Therefore, in some embodiments, the chemical micro heating elements 100 also comprise a protective barrier 116 for storage, thus comprising a two-part system: i) a lithium-filled acrylic channel and ii) a soluble mixture of mineral oil and mannitol forming a protective storage barrier 116. In some embodiment, such as that shown in FIG. 4, the protective barrier 116 may also comprise a protective barrier holder 120 coupled to the reactive solid holder 114.

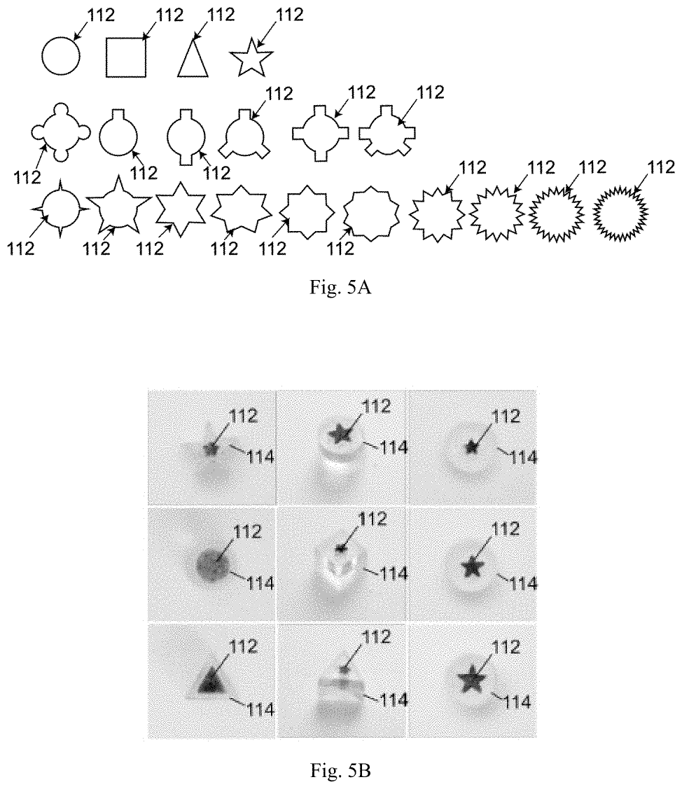

FIG. 5A shows exemplary embodiments of various cross-sectional profiles of the channel 112 for holding the lithium in accordance with various embodiments. In order to obtain a desired heating profile, one of skill in the art may suitably select a given cross-sectional profile of the channel 112. FIG. 5A shows a plurality of non-limiting possible cross-sectional profiles, yet one of skill in the art may also select from other shapes not shown. FIG. 5A shows various cross-section profile shapes for exemplary purposes and should not be considered limiting. The various, cross-section shapes, for example, without intended to be limiting may be a square, a rectangle, a triangle, a star, pentagram, a heptagram, a great heptagram, an octagram, an enneagram, a great enneagram, a decagram, a small hendecagram, a hendecagram, a great hendecagram, a grand hendecagram, a dodecagrams, a small tridecagram, a tridecagram a medial tridecagrams, a great tridecagrams, a grand tridecagram, a tetratdecagram, a great tetradecagram, a small pentadecagram, a pentadecagrams, a great pentadecagram, a small dexadecagram, a hexadecagram, or a great hexadecagram. Furthermore, FIG. 5B is a photograph of various exemplary reactive solid holders 114 where the channel 112 has various cross-sectional profiles in accordance with various embodiments. The external shape of the reactive solid holder 114 may be chosen in accordance with parameters of the first vessel 102. Then, the size, shape and length of the channel 112 is chosen and cut, or otherwise formed, into the reactive solid holder 114. In some exemplary embodiments, the channel 112 may be laser cut into the reactive solid holder 114. In other embodiments, the reactive solid holder 114 may be extruded with the channel 112 of a desired size and shape formed therein.

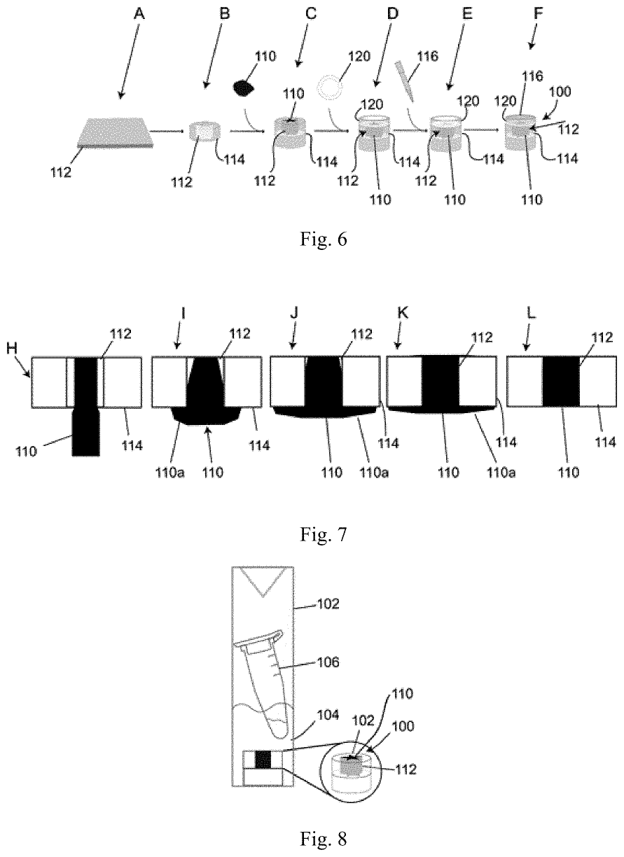

An exemplary workflow for the production of the instantly disclosed chemical micro heating elements 100 is shown in FIG. 6. For example, at A an acrylic material sheet 122 is selected. Although an acrylic sheet, or other suitable material, having various desired characteristics may be chosen, in the embodiments as disclosed herein acrylic chosen as the housing was selected to house the lithium due to its low thermal expansion coefficient of 75×10⁻⁶ m/m/K in order to minimize the effect of heat on the dimensions and morphology of the channel. The reactive solid holder 114 and the channel 112 were then cut from the acrylic sheet 122 as indicated at B. At C, lithium 110 was compressingly installed into the channel and will be discussed in more detail below. Furthermore, at C, the bottom seal was coupled to the reactive solid holder 114 so as to seal in one end of the channel 112 once the lithium 110 is installed. The protective barrier holder 120 was coupled to the reactive solid holder 114 at D and E a soluble protective barrier 116 was installed into the protective barrier holder 120 so as to seal the other end of the channel 112 having the lithium 110 therein for storage. Accordingly, to allow for the installation of the soluble protective barrier 116 into the protective barrier holder 120, the protective barrier holder 120 may be a ring-shaped mold to which mineral oil, mannitol and other excipients (as may be desired or required) are added so as to form the soluble protective barrier 116. At F the completed chemical micro heating element 100 is shown.

As noted above, and with reference to FIG. 6, steps B and C and FIG. 7, the malleable reactive solid, such as lithium 110, is inserted into the channel 112 as shown at G. The malleable reactive solid 110 is then worked into the channel 112 as shown in H, I, J, K so as to occupy substantially all of the void of the channel. Once the entirety of the void of the channel 112 is filled with the malleable reactive solid 110, the excess 110a, as shown in the progression from J to K, is removed. Therefore, based on the desired heater characteristics, the channel size, shape and length are chosen and the malleable reactive solid 110 is installed therein, substantially devoid of any air space. The chemical micro heating element 100 is then completed according to the steps outlined in FIG. 6. It should be appreciated that, although FIG. 6 schematically shows a workflow for the production of embodiments of a chemical micro heating element 100 as disclosed herein, one of skill in the art may determine other methods of production and such are to be considered within the scope of the current disclosure.

In terms of providing a chemical micro heating system 101 as noted above, the chemical micro heating elements 100, in some embodiments, as disclosed herein, are intended to be placed in a first vessel 102 containing a liquid 104, generally an aqueous solution, so as to render a liquid bath which is capable of heating the contents of a second vessel 106. It is known in the art that various biochemical assays and reactions require different temperatures and/or a variety of temperatures in order to work. Accordingly, the chemical micro heating elements 100 as disclosed herein are produced, as discussed in more detail below, to heat a given volume of a liquid to a desired temperature or temperature range for a desired period of time. The second vessel 106, as shown in FIG. 1, for example, can be placed in the liquid bath of the chemical micro heating system 101 so as to heat the contents of the second vessel 106 places in the bath. Some biochemical reactions, such as the polymerase chain reaction (PCR) require cycling the temperature of the content of the second vessel (as would be known in the art), through a cycling series of denaturation, annealing, and elongation steps, at temperatures, for example, typically in the ranges of about 94° C. to 98° C., 48° C. to 72° C., 68° C. to 72° C. Therefore, in order to undertake such a reaction in an electricity-free environment, more than one, such as two or three types of chemical micro heating elements 100 would be provided, each capable of providing heat to provide a chemical micro heating system 101 for each step of denaturation, annealing, and elongation through which the second vessel 106 can be cycled in order to complete a given PCR. Furthermore, given the time to exhaustion (or hold-over time) of the exothermic reaction of the chemical micro heating element 100, more than one chemical micro heating element 100 may need to be provided for each of the required temperature stages. In other biochemical reactions, such as an enzymatic digestion of DNA, only one temperature specified chemical micro heating element 100 may need to be provided as cycling through various temperatures may not be required.

Various aspects of the chemical micro heating element 100 and micro heating systems 101 of the instant disclosure will be described in more detail below so as to provide a more thorough understanding of the subject matter of the instant disclosure.

### EXAMPLES

### Example 1—Providing Precise and Tunable Temperatures

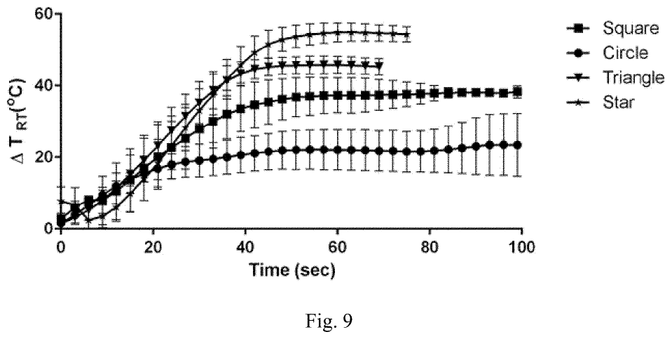

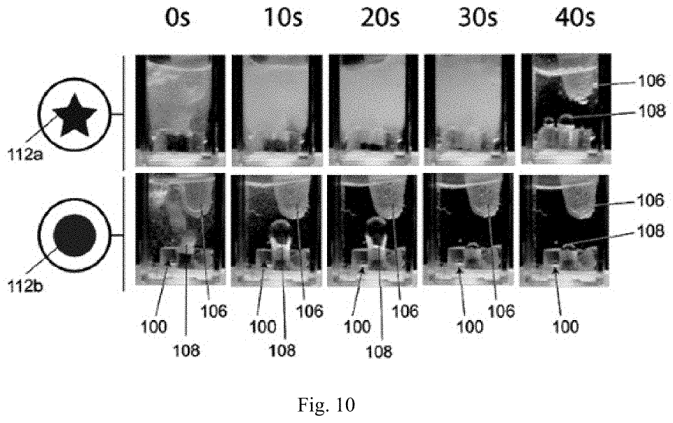

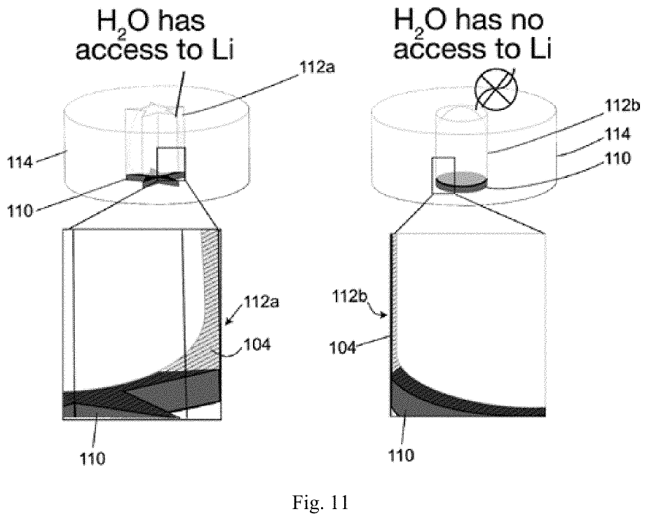

Precise and tunable heating was achieved by varying the shape and surface area, mutually exclusively, of the acrylic channels of the heater. In order to determine the effect of shape and surface area on the precision and tunability of temperatures, a simpler version of the miniature heater was used. This version only had one component: an acrylic mold filled with lithium 110, as shown in FIG. 8. The aim of the testing was to develop a chemical micro heating element that can provide temperatures in the range of 37 to 65° C. (ΔT_{RT}=12 to 0° C.) with 5° C. of precision, which are typical requirements for enzymatic assays. As a first portion of the development and testing, precise heating was able to be provided by varying the shape of the acrylic channel 112. The shape of the channel 112 was optimized to increase hydrogen bubble 108 clearance from the channel 112 to improve the interaction between the reactants, lithium 110 and water 104. A plurality of lithium-filled acrylic molds with circular, square, triangular and star-shaped channels 112 of fixed surface area were developed. The shapes tested were where the channel 112 had a star, circle, square and triangle cross-sectional shape. FIG. 9 is a line graph showing the effect of the various cross-sectional shapes on heating 50 μl of water in a test tube 106, where the chemical micro heating element 100 was placed in a cuvette containing 1 mL of water 104 to react with the lithium 110 in a first vessel 102. The temperature of the tube was monitored using a thermal camera and hydrogen bubble generation was monitored with a video camera. Surprisingly, as can be seen in the graph of FIG. 9, it was observed that channels 112 with sharper and more numerous angles provided more reproducible temperature profiles and final temperatures. Circular channels provided the most irregular heating while star-shaped channels provided the most precise and reproducible temperature profiles. As can be seen in the photograph of FIG. 10, this disparity was observed due to the lack of clearance of hydrogen gas 104 from the circular channels 112, which formed Taylor bubbles, or elongated hydrogen bubbles several times longer than the diameter of the channel. It is believed that at this size scale, surface tension forces are more predominant over buoyancy forces, which unpredictably impedes rising bubble velocity. When the channels are blocked with slower moving Taylor bubbles, less water is able to access the lithium to continuously provide heating. Conversely, with the star-shaped channel, sharper angles resulted in more water being retained in the corners, as is shown schematically in FIG. 11 comparing the star-shaped cross-sectional channel 112a and the circular-shaped cross-sectional channel 112b. With increased retention of water in the corners, more water 104 can move downwards and access lithium 110 while still allowing for the clearance of hydrogen bubbles 108. This allows for the reaction to proceed to provide continuous hydrogen bubble generation and precision in heating. Accordingly, although various shaped cross-sections of the channels may be used, in preferred embodiments, the star-shaped channels 112a are used. Thus, in further experiments, the star-shaped channels 112a were used to further build the platform to provide tunable temperatures.

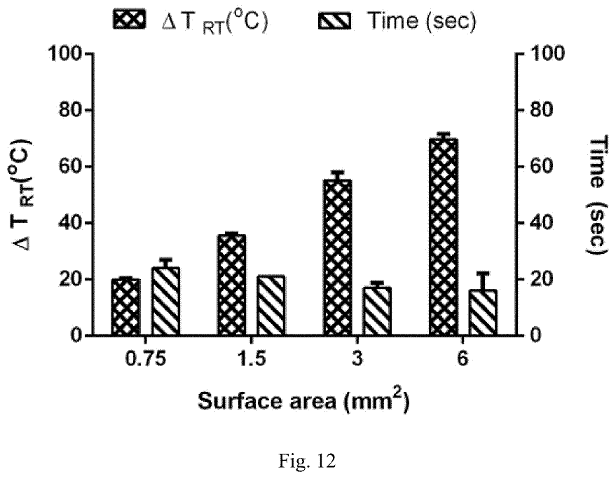

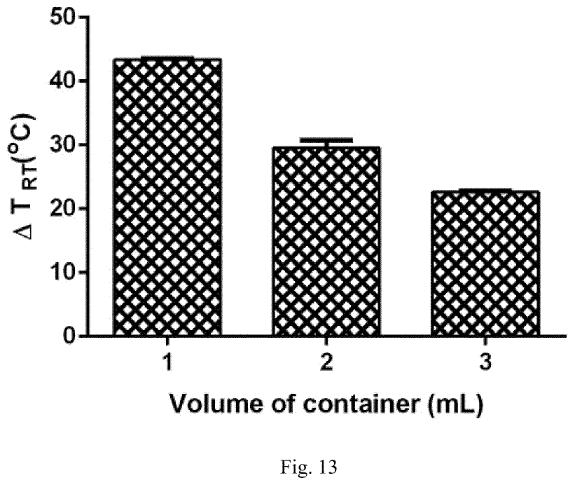

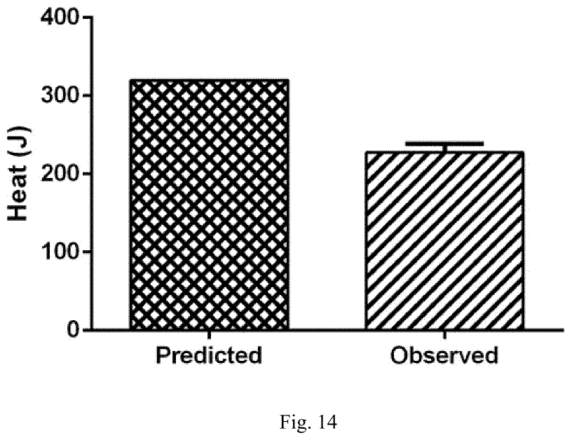

Building on the surprising discovery that star-shaped channels 112a allow for a higher degree of precision to the temperatures compared to other tested channel cross-sectional shapes, the surface area of the channel 112 openings was varied in order to study the changes in temperature and to produce chemical micro heating elements 100 with a desired temperature range. It was determined that by varying the surface area of the openings, the amount of water 104 accessing lithium 110 could be increased or decreased and thus the resultant temperature of the bath 104 tuned. The surface area of the star-shaped channel 112a was from 0.75 mm² to 6 mm² (˜1-10 mg mass of lithium) to provide a range of temperatures from ˜40 to ˜100° C. (ΔT_{RT}=˜20-70° C.), as shown in the histogram of FIG. 12. The exposed surface area was used as a lever to vary the total mass of lithium 110 in the channel 112a, where larger surface areas provided more exposure of lithium 110, to water 104. Given the high heating rate of the miniature heaters, the total mass of lithium therefore governed the final temperature of the solution. Surface area of the channel openings was thus used as an indirect physical parameter to tune the final temperature of the solution. In addition to varying the surface area of a channel 112, it is also possible to provide tunability in temperature by varying the volume of water in which the heater is immersed, as shown in the graph of FIG. 13 where 3 mm² star-shaped channels 112a were filled with lithium 110 and placed in either 1 mL, 2 mL, or 3 mL of water bath 104 and the final temperature determined by monitoring the temperature of the reaction tubes filled with 50 μl of water with a thermal camera. Accordingly, it has been shown that a precise and a broad range of temperatures can be provided by modifying both the shape and surface area of the acrylic channel 112 of the chemical micro heating element 110.

### Example 2—Hold-Over Time

In order to demonstrate that the chemical micro heating elements 100 can provide sustained heat for required time periods in order to be usable for conducting biochemical assays, testing was undertaken. A similar testing set-up was employed as noted above and shown in FIG. 8. The aim of the testing, inter alia, was to provide a chemical micro heating element 100 able to maintain a range of temperatures within 5° C. of precision for 10 to 15 minutes. It will be appreciated by those of skill in the art that varying the parameters will allow for chemical micro heating elements 100 which can produce different temperatures to the water baths and for different time periods.

In terms of the use of the chemical micro heating elements for use in biochemical assays, since these tests have multiple steps which require different temperatures, each step may conceivably require a specific temperature to be maintained over 10 to 15 minutes. Therefore, first, to increase hold-over times, the surface tension of the solution 104 (water bath 104, as shown in FIG. 1) was varied to reduce the clearance rate of hydrogen bubbles. By decreasing the hydrogen bubble clearance rate, the rate of heating was decreased in order to prolong maintaining a target temperature in the minute scale. Roughly 70% of the heat generated by the heater is transferred to the sample without the use of any insulation, as shown in the graph of FIG. 14. With reference to the graph of FIG. 14 and employing a set-up similar to that shown in FIG. 8, the total energy input possible was calculated by considering the mass of lithium in a 3 mm² star-shaped channel 112a (10 mg of lithium) and the energy density of lithium (222 kJ/mole). The observed energy required or total transferred to the sample tube was determined by finding the area under the curve of mcdT/dt vs. time for a 3 mm² star-shaped channel chemical micro heating element 100. The difference in total available vs. total transferred values is due to the loss of heat due to lack of insulation.

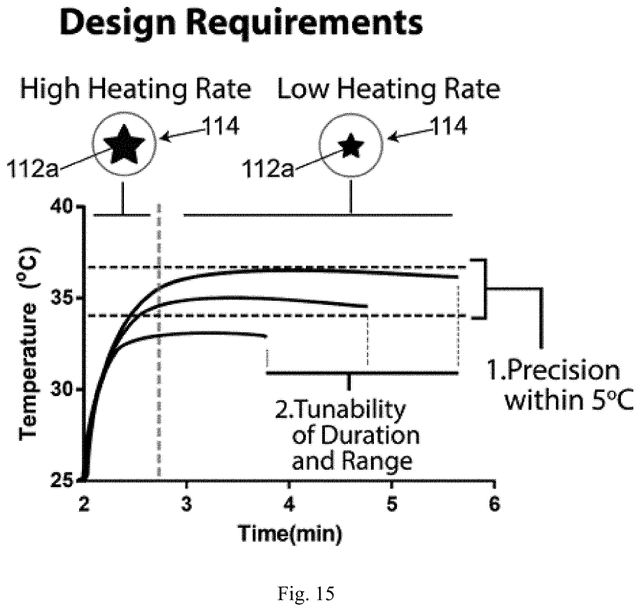

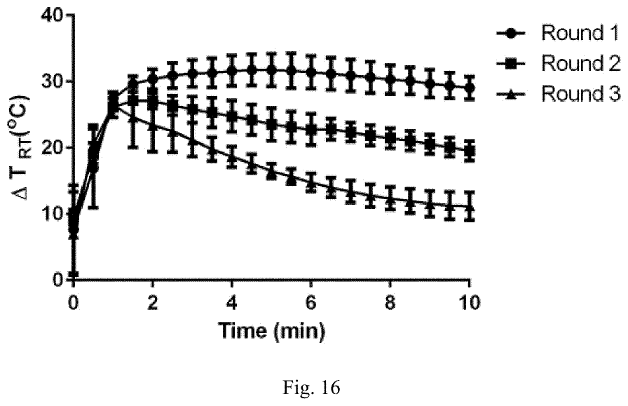

To have hold-over times in the minute scale, a two-heater approach was used: one with a high-heating rate and another with a lower heating rate, as shown in FIG. 15. The first heater, noted in FIG. 15 as “high heating rate”, would bring the solution quickly up to a target temperature while the second, noted in FIG. 15 as “low heating rate” would maintain the temperature for a period of minutes. To develop a heater with a lower heating rate, the surface tension of the solution in which the heater was immersed was varied by adding different amounts of the surfactant, SDS. With the inclusion of surfactant however, a decrease in the peak temperature reached with each subsequent addition of heaters was observed. It was hypothesized that this decrease in heating is due to the rate of reaction being reduced by LiOH byproduct build-up, as shown in the graph of FIG. 16. With regard to FIG. 16, a 3 mm star-shaped channel 112a chemical micro heating element 100 (denoted as round 1) having a channel depth of 3.175 mm was added to a 1% SDS solution with 5% silicone antifoam at 55° C. Subsequent additional of chemical micro heating elements, denoted as round 2 and round 3, results in a decrease in peak temperature reached as well as the duration of the time heating is maintained.

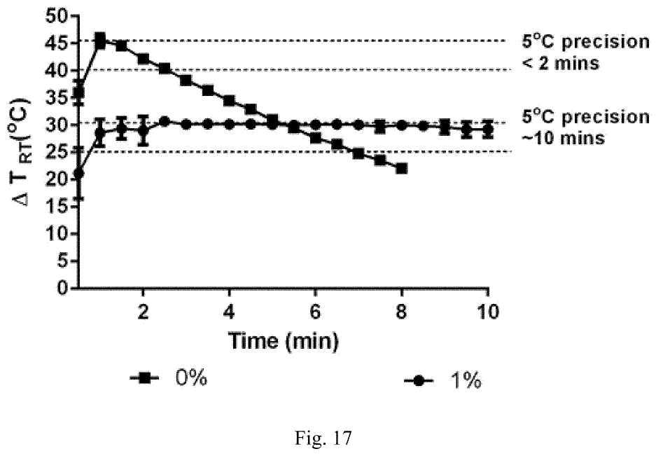

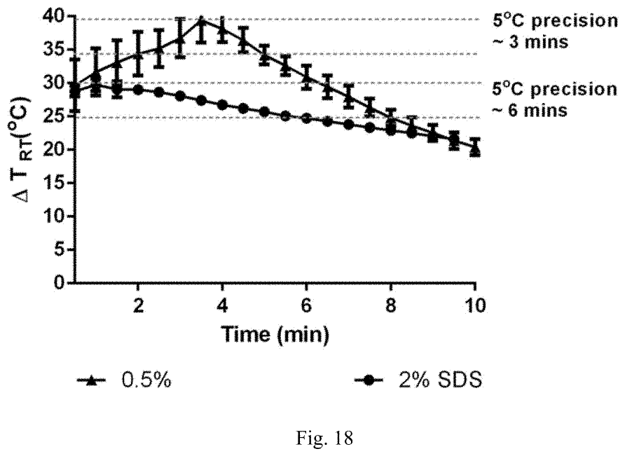

In order to demonstrate the effect of SDS in the bath solution 104 on hold-over time versus temperature, the ability of the chemical micro heating element 100 to heat the bath solution 104 was tested with varying concentrations of SDS in the bath solution 104. For simplicity, instead of using a high heating rate chemical micro heating element to bring the bath solution up to a target temperature, the solution was heated to 55° C. (ΔT_{RT}=30° C.). A low heating rate heater, along with SDS and antifoam to minimize foam formation was added to the bath solution 104. Briefly, chemical micro heating elements having 3 mm² star-shaped channels 112a filled with lithium were immersed in a 0%, 0.5%, 1%, and 2% SDS baths with 5.0% antifoam solution, as noted in FIGS. 17 and 18. FIGS. 17 and 18 are graphs which show the change in temperature versus hold-over with varying concentrations of SDS in the both solutions 104. The temperature of both the solutions was indirectly measured by monitoring the temperature of a reaction tube 106 with 50 μl of water using a thermal camera. Duration was determined as the period of time at which a target temperature was maintained within 5° C.

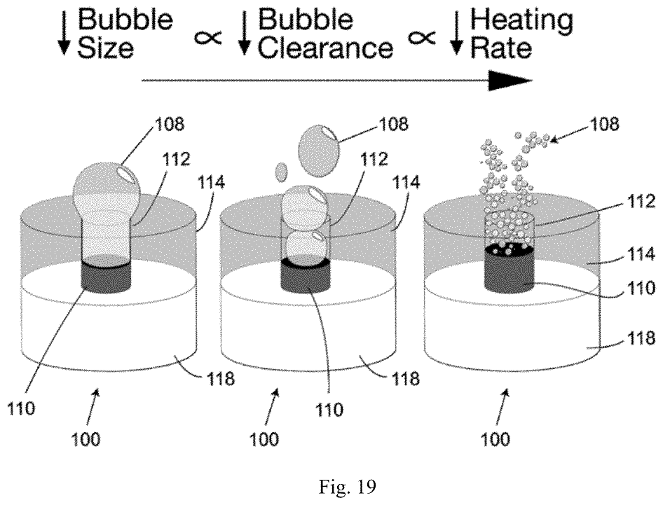

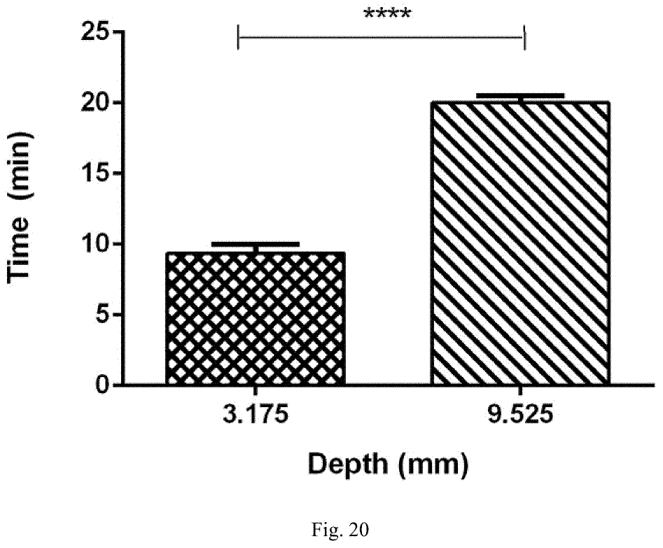

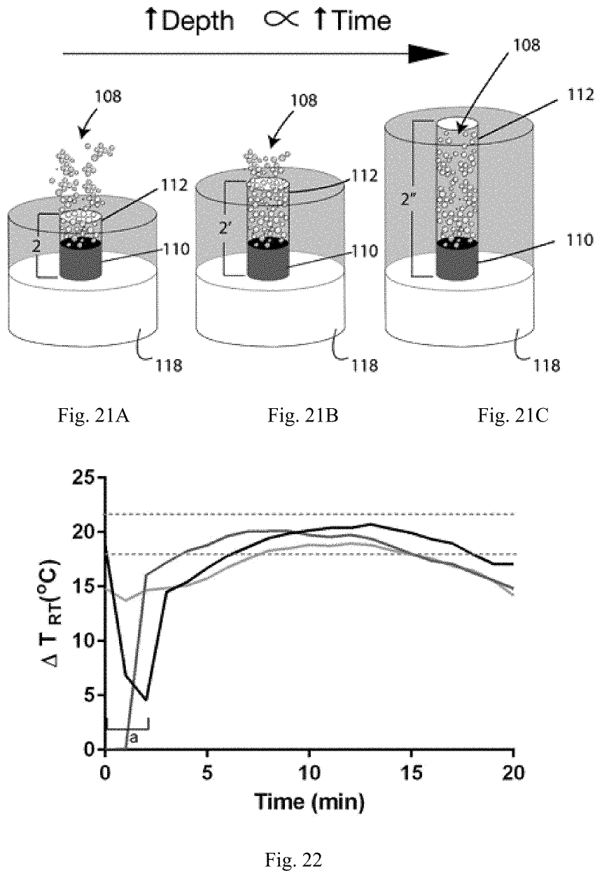

At 1% SDS solution, the temperature of the solution was held constant (+/−2.5° C.) for 10 minutes. Below 1% SDS the hold-over times were shorter than 10 minutes, while above 1% SDS the heating rate was too low to maintain temperature within +/−2.5° C.). This phenomenon of providing lower heating rates is believed to occur as a result of the interplay between surface tension and hydrogen bubble size. With the addition of surfactant, the surface tension of the solution decreases. In a solution of lower surface tension, smaller hydrogen bubbles are generated, resulting in slower upward movement, greater bubble packing density, and reduced clearance of bubbles. FIG. 19 is a schematic representation of this phenomenon. This decrease in bubble size in turn decreases the rate of water accessing lithium for consumption, thereby decreasing the heating rate. To further increase hold-over times, the depth of the channel may be increased, as shown by the graph of FIG. 20. As schematically shown in FIGS. 21A-21C, at a constant heating rate, the depth of the channel, in increasing length variations Z, Z′ and Z″ in embodiments A, B and C governs the amount of lithium 110 available for consumption. Accordingly, as represented in FIG. 21, there is a proportionality between channel depth and hold-over times for a fixed SDS concentration and channel surface area. FIG. 22 shows three individual replicates and time durations at which a 1.5 mm2 star-shaped channel 112a with a depth of 9.525 mm maintains a target temperature (a=noise due to initial position of the test tube in the cuvette with the chemical micro heating element).

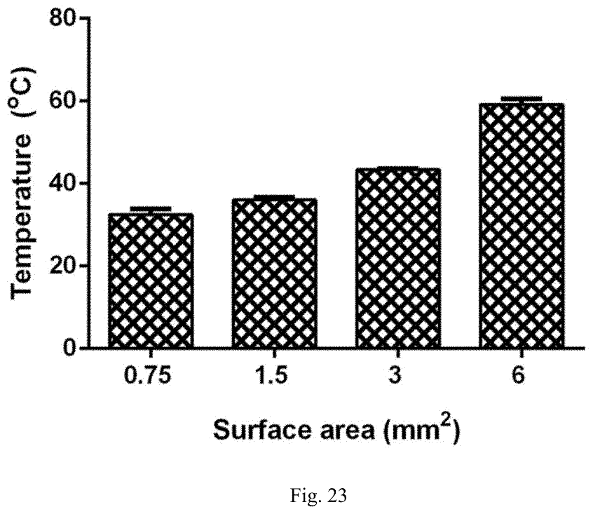

Lastly, it was demonstrated, using a 1% SDS concentration, that the temperature of the solution could be modulated in the minute scale. FIG. 23 shows the effect of varying the surface area of lithium exposed on temperature and time. The surface area of the acrylic channel openings to acquire a range of temperatures that were maintained for ˜10 minutes is shown FIG. 23. Therefore, in addition to the showing of precise and tunable temperatures by modulating shape and surface area of the acrylic channel noted above, hold-over times of the chemical micro heater can be increased by including a surfactant in the solution and varying the depth of the acrylic channel.

### Example 3—Storage of the Chemical Micro Heating Elements

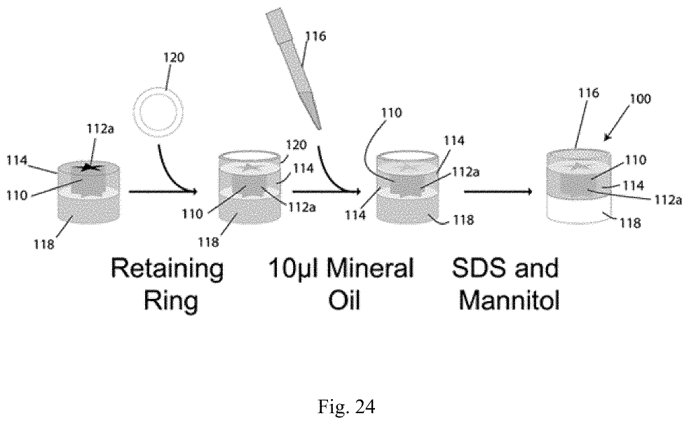

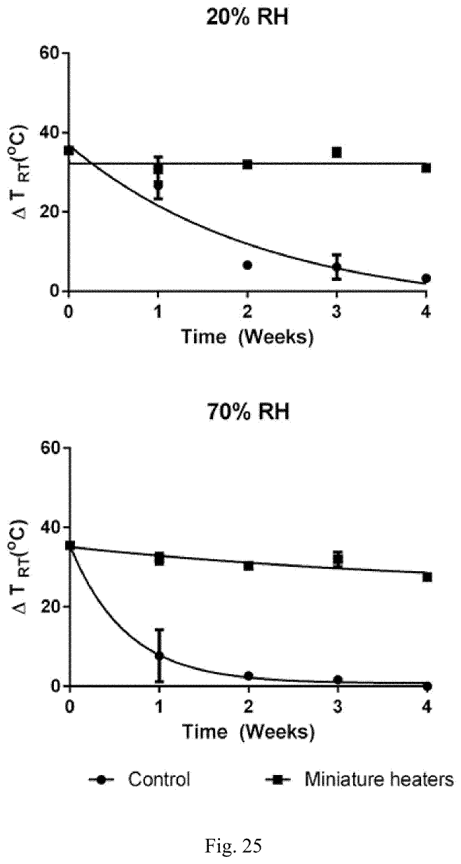

As a possible environment for using the chemical micro heating elements disclosed herein is in a resource-limited setting, their performance in settings with limited infrastructure as well as user training, was simulated and tested. The heaters were tested for performance in highly humid environments, where performance of the heaters can be drastically reduced, in order to simulate settings with limited infrastructure. Briefly, chemical micro heating elements 100 were produced as substantially described with relation to FIG. 6, where the chemical micro heating element 100 includes adding stabilizing excipients to the acrylic mold filled with lithium 110. To the mold filled with lithium 110, a ring shaped acrylic mold 120 was fitted, to which mineral oil, mannitol as well as SDS were added so as to produce the protective barrier 116, as shown in FIG. 24. First, to test the performance of the heaters in conditions of high humidity, the heaters were kept with and without excipients at 20% and 70% relative humidity (RH) for a period of 4 weeks. The final temperature reached at each time point when the chemical micro heating element 100 was immersed in water 104 was used as a metric to determine stability. In the presence of protective barrier 116 of excipients, the heaters reached ˜55° C. (ΔT_{RT}=30° C.) for a period of 4 weeks while in the absence of excipients the peak temperatures drastically decreased at 20% and 70% RH, as shown the graphs of FIG. 25. The immiscible nature of mineral oil as well as the non-hygroscopicity of mannitol limit the interaction of lithium with moisture in the air, thereby providing stability. The miniature heaters therefore perform equally well in limited infrastructure environments with lack of controlled humidity.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A heating element comprising: a reactive solid holder having a channel; the channel being defined about a perimeter thereof by at least one side wall; a chemical which on contact with a suitable liquid undergoes an exothermic reaction and a gas is produced; and wherein the chemical is packed into the channel so as to completely fill the space afforded by the channel against the perimeter of the at least one side wall.

2. The heating element of claim 1, wherein the cross-section of the at least one side wall is a continuous loop.

3. The heating element of claim 2, wherein the continuous loop is a circle or an oval.

4. The heating element of claim 1, wherein the cross-section of the at least one side wall is a multi-sided loop having one or more angled corners.

5. The heating element of claim 4, wherein the multi-sided loop having one or more angled corners has a cross-sectional shape of a square, a rectangle, a triangle, a star, pentagram, a heptagram a great heptagram, an octagram, an enneagegram, a great enneagram, a decagrams, a small hendecagrams, a handecagram, a great hendecagras, a grand hendecagram a dodecgram, a small tridecagram, a tridecagram, a medial tridecagram, a great tridecagram, a grand tridecagram, a tetratdecagram, a great tetradecagram, a small pentadecagram, a pentadecagrams, a great pentadecagram, a small dexadecagram, a hexadecagram, or a great hexadecagram.

6. The heating element of claim 1, wherein the channel is closed at one end thereof.

7. The heating element of claim 6, wherein the channel is closed about the one end thereof by the coupling of a bottom seal to the reactive solid holder.

8. The heating element of claim 1, further comprising a protective barrier for selectively sealing the chemical, located in the channel, from exposure.

9. The heating element of claim 8, wherein the protective barrier is soluble in the suitable liquid so as to selectively allow exposure to the suitable liquid.

10. The heating element of claim 9, wherein the protective barrier is contained in a protective barrier holder coupled to the reactive solid holder.

11. The heating element of claim 8, wherein the protective barrier is comprised of at least mineral oil and mannitol.

12. The heating element of claim 1, wherein the chemical is at least one reactive alkali metal.

13. The heating element of claim 1, wherein the chemical is sodium, potassium, or lithium or combination thereof.

14. The heating element of claim 1, wherein the chemical is lithium.

15. The heating element of claim 1, wherein the channel has an opening of from about 0.75 mm² to about 6 mm².

16. The heating element of claim 1, wherein the channel has an opening of about 3 mm².

17. The heating element of claim 1, wherein the channel as length of from about 0.01 mm to about 15.0 mm.

18. The heating element of claim 1, wherein the channel as length about 9.525 mm.

19. A liquid bath heating system comprising: the heating element of claim 1; a first vessel; the suitable liquid contained in the first vessel; and wherein the liquid is the suitable liquid to react with the chemical.

20. The liquid bath heating system of claim 19, wherein the suitable liquid is water.

21. The liquid bath heating system of claim 19, wherein the suitable liquid is an aqueous solution.

22. The liquid bath heating system of claim 21, wherein the aqueous solution comprises SDS.

23. The liquid bath heating system of claim 21, wherein the aqueous solution comprises SDS and antifoam.

24. The liquid bath heating system of claim 22, wherein the concentration of SDS is from about 0.001% to about 3.0%.

25. The liquid bath heating system of claim 22, wherein the concentration of SDS is about 1.0%.

26. The liquid bath heating system of claim 19, wherein the suitable liquid is provided in volume of from about 0.5 mL to about 10 mL.

27. The liquid bath heating system of claim 19, wherein the suitable liquid is provided in volume of from about 1.0 mL to about 3.0 mL.

28. The liquid bath heating system of claim 19, further comprising a second vessel disposed in the suitable liquid for receiving therein a sample to be heated.
